(19) United States
(12) Patent Application Publication
(10) Pub. No.: US 2026/0268420 A1
(43) Pub. Date: Sep. 10, 2026

(54) VIRTUAL BOTTLE MANAGEMENT METHOD

(71) Applicant: Masahiro KOKO, Tatsuno-shi (JP)

(72) Inventor: Masahiro KOKO, Tatsuno-shi (JP)

(21) Appl. No.: 18/847,635

(22) PCT Filed: Dec. 15, 2023
(86) PCT No.: PCT/JP2023/045118

§ 371 Date: Sep. 16, 2024

(30) Foreign Application Priority Data
Feb. 21, 2023 (JP) 2023-025383

(51) Int. Cl. G06Q 50/12; G06K 7/14; G06Q 10/02

(52) U.S. Cl. CPC G06Q 50/12; G06K 7/1417; G06Q 10/028

(57) ABSTRACT

A virtual bottle keeping system includes a user terminal provided with a bottle icon as a virtual bottle keeping certificate, a store side terminal which has a function which can communicate via the user terminal and the wireless circuit in a store, and a two dimensional code system having a customer entry code and a customer order code. A terminal backs up the data of the virtual bottle instead of an actual bottle. The customer registration information is in the user side terminal and the store side terminal. When the customer comes to the store, a seat signal indicating a seating position and an order signal are transmitted from the virtual bottle icon of the customer portable terminal. A desired amount of alcohol is provided upon receiving an order from a customer, and the data is updated by an update system.

### TECHNICAL FIELD

The present invention relates to a method for performing a virtual bottle keeping management system by using a wireless line in each bar or drinking store, and an automatic alcohol service system used for the virtual bottle management method.

### BACKGROUND OF THE INVENTION

In Japan, there has been performed a liquor service called “bottle keeping system” in a drinking bar store (or restaurant) in place of shot service, where the customer purchases and keeps his own bottle for his personal use in a store and he orders the shot service from his own bottle.

This bottle keeping method or system has been popular for a long time in Japan, where a user in a store firstly purchases an alcoholic bottle containing beverages (such as whiskey, brandy, or shochu) on a bottle-by-bottle basis (not a shot basis) and secondly the personal bottle is kept for each personal shot service in the store instead of a standard shot service from a store bottle, so he can enjoy the shot service at each visit as long as the liquor remains in the bottle deposited in the shop.

According to this bottle keeping system, the user can enjoy drinking alcoholic beverages at very cheaper cost than the regular shot order. That is, the bottle keeping is a useful service for the user. On the other hand, since a user who keeps a bottle is highly likely to use the same store again because of the cheaper drinking cost, so the bottle keeping has an effect of promoting the user's visit to the shop more frequently, and thus it can be said that it is useful for the shop.

Taking the above merit into consideration, there has been proposed a drinking network system in a big chain of restaurant store where the drinking system is connected via the Internet and the user can drink as a member at all of the chain stores (Patent Documents 1 and 3), but there is a problem in that, a database should be provided to be shared by group stores and further a management center is required, so that a huge cost is required for the system construction. For this reason, as another system, an electronic recording medium system has been proposed where the user or customer keeps the recording medium capable of storing information such as the brand, the remaining amount in the bottle, in order to perform the bottle management (Patent Document 2). However, the recording medium system has a weak point in that the user tends not to get a meaning or feeling of the real bottle keeping in the store, because this bottle keeping medium should not give the customer the same feeling of the real bottles in the store. That is, it is difficult to make the user to have a real image of keeping the bottle in the mind, even though the volume of alcohol bottle can be controlled by the electronic recording medium,.

### PRIOR ART DOCUMENTS

### Patent Document

[Patent Document 1] JP 2002-92122 JP.

[Patent Document 2] JP 2006-285551 JP.

[Patent Document 2] JP 2017-16661 JP.

### SUMMARY OF THE INVENTION

### Problem to be Solved by the Invention

Taking this problem into account, it is an object of the present invention to provide a virtual bottle keeping method or system in a store instead of a real bottle keeping management, where the management of the virtual bottle keeping is performed via Bluetooth, Wi-Fi, and a similar mutual radio communication function (hereinafter, referred to as a wireless line in a store)

### Means for Solving the Problem

According to the present invention, it is an object to provide a virtual bottle management system for storing alcoholic beverages, which comprises 1) a user side terminal 100 which is customer side mobile terminals, such as a personal smart phone or tablet, 2) a store side terminal 200 which is a PC or the like having a function which can communicate via a Bluetooth, a Wi-Fi system or a similar mutual radio wave communication function (wireless line in a store 500), 3) a two-dimensional code system 300 provided with at least a membership two dimensional code 301 represented by the store QR code (registered trademark) for registering a virtual bottle with a store name, and a seating two dimensional code 302 represented by QR code for specifying a sitting seat position, 4) a back-up terminal 400 which backs up the data of the store side terminal 200, in order to be cooperated by the wireless line 500 in the store, and to memorize the keeping data of the virtual bottle B instead of an actual bottle with a bottle membership information,

wherein the user terminal 100 is provided for a first step A) with a data reading means 101 for reading the two dimensional codes 301, 302 of a store represented by QR code, and a communication function 102 which cooperates with the store side terminal 200 via the two dimensional code system 300 in order to 1-1) read the store code 301 with the user terminal 100, 1-2) communicate with the store side terminal 200, 1-3) register a customer registration information, 1-4) pay a bottle fee for keeping a personal bottle, and 1-5) obtain the bottle icon 103 used as a virtual bottle keeping proof from the store side;

wherein the store side terminal 200 is provided for a second step B) with the virtual bottle registration means 201 which records a virtual bottle data with membership information instead of an actual bottle and an order reception means 202 which receives an order relating to a volume and so on; and an updating means 203 which subtracts a consumed volume from storage quantity of a virtual bottle in order to 2-1) read the two dimensional code 302 represented by a QR code of a seating position with the user terminal 100 when a customer comes to the store, and 2-2) transmit a store seating signal 501 to the store side terminal 200;
wherein the user terminal 100 is operated for a third step C) to transmit an order signal 502 to the store-side terminal 200 in order to request a specified amount of alcohol through the virtual bottle icon 103 in the user terminal 100;
wherein the store side terminal is operated for a fourth step D) to receive the seating signal 501 and the order signal 502 in order to confirm the amount of alcohol ordered from the designated virtual bottle, and to update the provided amount of alcohol by subtracting from the stored amount of alcohol in the virtual bottle,
wherein the store-side terminal 200 is operated for a fifth step E) to transmit the updated data to the user terminal 100 and also to transmit the updated data to the backup terminal.

In particular, the present invention is characterized in that the bottle keeping step A), the entrance seating step B), and the ordering step C) can be operated by using the two-dimensional codes as represented by a QR code (registered trademark). In this specification, the QR codes are used as a typical example of a two-dimensional code.

### Effect of the Invention

According to the present invention, the following advantages are given to the user and the store.

1) the user can confirm anytime whether or not the right of keeping a bottle exists in a store, because the customer-side mobile terminal 100 is provided with the bottle keeping proof icon 103. It is also possible for the user to confirm the remaining amount in the bottle from the outside without visiting the store by using the bottle keeping proof icon 103, so it is more convenient for the customer than the real bottle keeping management.

2) although the virtual bottle is not the same as a real bottle, it is important that the user can be given substantially the same feeling or image as the real bottle. That is, according to the present invention, together with the above customer confirmation, the store side is able to confirm a communication with the customer by reading the customer contact through the two-dimensional code 302 from the bottle keeping icon 103. In addition, since the virtual bottle can be specified by an order from the icon 103 of the customer terminal 100 and the alcohol of the order can be provided, it can be said that the feeling given from the icon 103 is comparable to the real bottle.

3) Further, the virtual bottle system does not need to have a space for placing a real bottle, and it is possible not only to quickly respond without the trouble of searching for a kept bottle but also to always provide a new liquor from the virtual bottle to a customer, so that the virtual bottle system is more convenient for the customer than the real bottle keeping system.

4) Since most people currently own smartphones as mobile terminals, the user can easily get the bottle keeping icon 103 firstly through the shop QR code 301 in the shop, and the user can request the order by the bottle icon 103 and the second QR code 302, so that the shop-side terminal 200 can be linked via the in-shop wireless line 500 such as a Bluetooth, a Wi-Fi, etc. to the user terminal 100. Therefore, an extremely inexpensive bottle control methods can be implemented in the respective shops with ease.

5) That is, according to the present invention, such a good virtual bottle management can be performed at low cost via an in-store wireless line using a two-dimensional code represented by two types of QR codes. In particular, according to the present invention, since the ordering signal is converted into a two-dimensional code represented by QR code, the automatic alcohol server device can be driven and the virtual bottles of the shop-side terminal and the customer-side terminal can be updated by the QR code system, resulting in that the automation of the virtual bottle control can be further promoted.

According to the present invention, there can be provided a virtual bottle managing method carried out by a virtual management system, which comprise 1) a customer side terminal (user terminal) 100 such as a smart phone and a tablet, 2) a store side terminal 200 which has a function for communicating with the user terminal 100, 3) a two-dimensional code system 300 provided with at least the two dimensional member code 301 represented by QR code for carrying out a membership registration, and the two dimensional coming-to-the-store code 302 represented by QR code which specifies a sign of coming to the store, and 4) a back-up terminal 400 which backs up the data of the store side terminal 200, and 5) a wireless circuit 500. In the virtual management system, it is preferable that an automatic sake server device 600 can be provided for supplying the sake drinking order upon receipt of an order signal 502 from the customer side terminal 100. For this case, the automatic sake or liquor server device 600 includes a two-dimensional code reader 601 in order to read or receive the order signal 502 directly from the customer side terminal 100 or through the store side terminal 200. In this example, it is preferable that the customer side terminal 100 has a function which inputs some personal authentication information, such as a customer's age, a face, and a fingerprint, when carrying out membership registration with the membership two-dimensional code 301, while the store side terminal 200 has a registering tool 201 which registers a personal authentication information, such as a member's age, a face, and a fingerprint. According to the present invention, the automatic liquor server device 600 can automate the liquor sales management by checking the age, the face, the fingerprint, and any other personal authentication information of the customer when receiving the order signal 502, and then if permitted, a shot signal 503 is transmitted to the automatic liquor server device 600 in order to supply the ordered alcohol, while the record of the virtual bottle of the shop-side terminal 200 is updated.

### BRIEF DESCRIPTION OF THE DRAWINGS

FIG. 1 it is a schematic diagram of a system for implementing a virtual bottle management method linked by an in-store wireless line configured in the present invention.

FIG. 2 It is a schematic diagram showing an example according to the present invention when the customer is sitting on a counter seat.

FIG. 3 it is a schematic diagram showing an example according to the present invention when the customer is sitting on a box seat.

FIG. 4 It is a flow diagram showing a case where a customer makes registration of the bottle when the customer enters the store.

FIG. 5 It is a flow diagram at the time of order when a customer transmits a sitting seat signal and a desired alcohol order from the registered bottle.

FIG. 6 It is a flow diagram at the time of providing a sake or alcohol from the automatic sake server device.

### EMBODIMENT

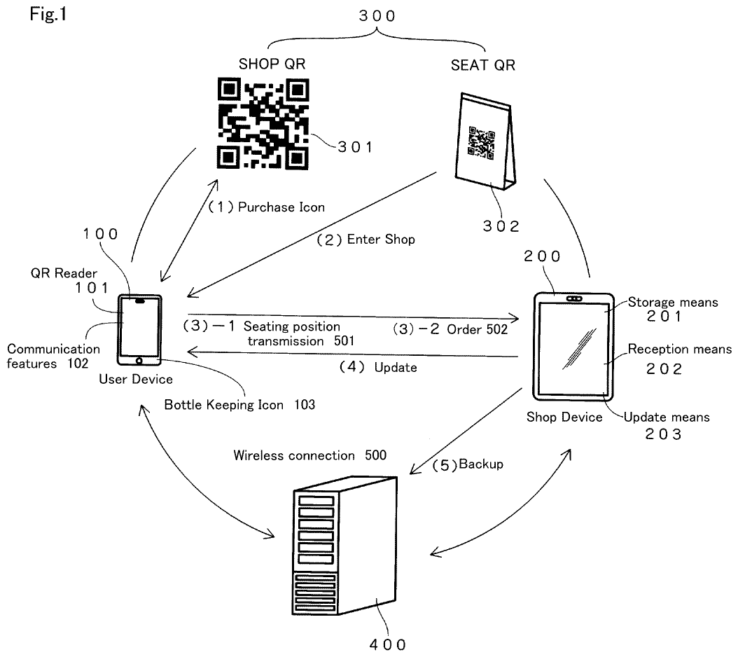

According to the present invention, there is provided a system for implementing a method of purchasing and managing a virtual bottle B with a member information of a bottle purchaser in place of a real bottle. As shown in FIG. 1, the present inventive system comprises 1) a user terminal 100 such as a smartphone which is a customer-side portable terminal, 2) a shop-side terminal 200 having a function capable of communicating with the customer-side portable terminal 100 via Bluetooth or Wi-Fi and a similar in-store wireless line 500, 3) a two-dimensional code system 300 comprising a two-dimensional code 301 represented by a shop QR code used for registering a member in a shop and a two-dimensional code 302 represented by a seating QR code installed in a seat for informing a sitting position at the time of entering the shop, 4) a back-up terminal 400 for backing up data of the shop-side terminal, and 5) an in-store wireless line 500 for linking the two-dimensional code 300 for communication in the store.

The user terminal 100 comprises 1) a reading unit 101 of a two-dimensional code represented by a QR code of a store, 2) a communication function 102 that cooperates with the store-side terminal 200 via the OR code system 300, and 3) a virtual bottle icon (TM named by BOTTLE KUN) 103 that is used as a virtual bottle keep certificate for registering the customer with the registration information on the store-side terminal 200.

On the other hand, the shop-side terminal 200 is provided with 1) a virtual bottle registration unit 201 for recording a virtual bottle in place of an actual bottle via a two-dimensional code 301 represented by a registered QR code together with member information; 2) a reception unit 202 for receiving, via the wireless line 500, A) the sitting seat signal 501 that indicates a seating position to be transmitted from the customer-side portable terminal 100 to the shop-side terminal 200, for example, via a two-dimensional code 302 represented by an entry QR code as well as B) an order signal 502 that is transmitted from a virtual bottle icon 103 of the customer portable terminal 100; and 3) an updating unit 203 that subtracts the amount of alcohol desired from the amount of storage of the virtual bottle.

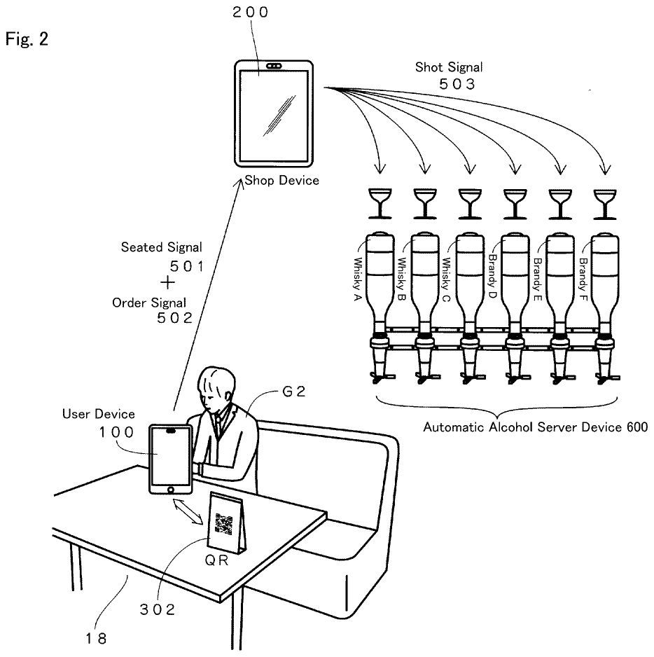

Note that the seating signal 501 and the order signal 502 may be ordered with the client ID by the order terminal 100 provided at the seating position by a customer G2 as in FIG. 2 or a customer G1 in Fi.3 in place of the user side terminal 100.

The backup terminal 400 can be operated to store the update data 401 which is transmitted from the store-side terminal 200 each time or after the customer pays a service fee and leaves the store.

The shop-side terminal 200 is designed to determine that an order is OK when the seating signal 501 and the order signal 502 are sent from the icon 103 of the customer-side portable terminal 100 via the in-shop QR code 302 through the in-shop wireless line 500, because the information of the icon 103 is used for specifying who is the guest, whether the guest is registered or not, while the information of in-shop OR code 302 is used for specifying where is the guest seat.

When the shop is provided with the order terminal 210 at the respective sitting positions in addition to the shop-side terminal 200, the customer who does not bring the user terminal 100 can transmit the order signal 502 together with the customer ID together with the sitting signal 501, so that it can be determined that the order is an in-store order, and the order can be received.

The backup terminal 400 may back up the update data via the in-store wireless line 500, but the backup terminal 400 can be also cooperated with the user terminal 100 by using the store ID or the client ID via the internet line if necessary. This is because the customer can check the remaining amount of the keeping bottle from outside by using the bottle keep icon 103 of the user terminal 100.

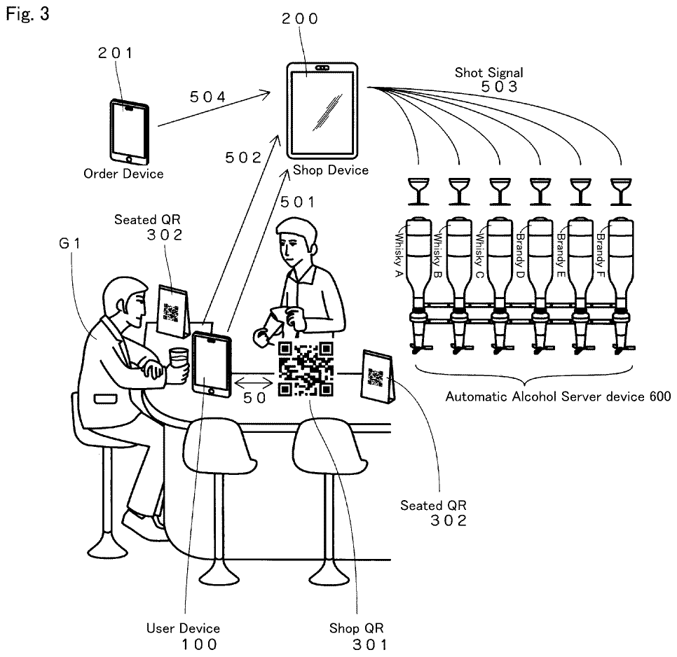

According to the present invention, we have two order systems. 1) as shown in FIG. 3, the customer G1 seated in the counter seat can order through the bottle management system of FIG. 1, and a desired liquor is supplied from the virtual bottle by the automatic liquor server device 600, while 2) as shown in FIG. 2, the customer G2 seated in the box seat can order through the bottle management system of FIG. 1, and a desired liquor is supplied from the virtual bottle by the automatic liquor server device 600.

The virtual bottle management method according to the present invention includes the following steps.

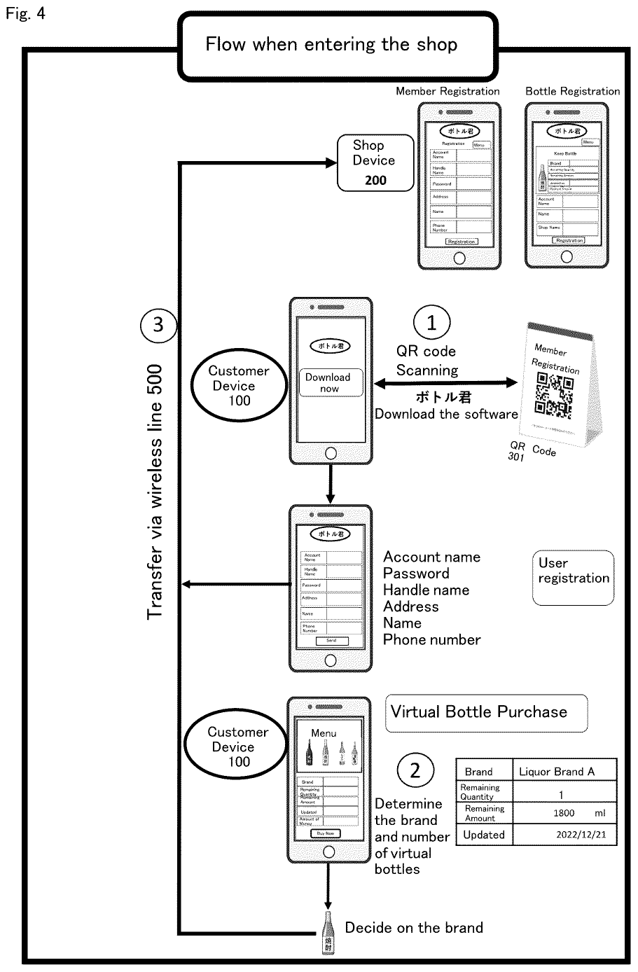

(1) Step 1 (for obtaining Virtual Bottle Icon: see FIG. 4):

As shown in FIG. 1, the user terminal 100 comprises a reading unit 101 for reading the two-dimensional code 300 represented by QR code of the shop and a communication function 102 that cooperates with the shop-side terminal 200. In this case, the shop-side terminal 200 comprises a virtual bottle registration unit 201 that records a virtual bottle together with member information in place of an actual bottle, so that the customer reads the shop code 301 at the user terminal 100 and communicates with the shop-side terminal 200, registers the customer registration information in the shop-side terminal 200, purchases a bottle, and obtains a bottle icon 103 that becomes a virtual bottle keep certificate from the shop.

Specifically, (1)-1) the customer reads the two-dimensional code 301 represented by the store QR code in OR code 300, 2) communicates with the store-side terminal 200, and 3) downloads the software. Here, 4) an account name, a password, a handle name, and an address name telephone are registered. 5) a bottle icon 103 is obtained, where a brand A is selected as an alcohol brand, a purchase of bottle number is input, a price is paid, so that a desired bottle purchase is completed in the shop side terminal 200 with the customer registration information. The bottle icon 103 obtained from the store side is used for proof of virtual bottle keeping. The remaining amount of alcohol in the bottle and the last update date are recorded therein, so that the update data is recorded not only in the customer-side mobile terminal 100 and the store-side terminal 200 but also in the backup terminal 400.

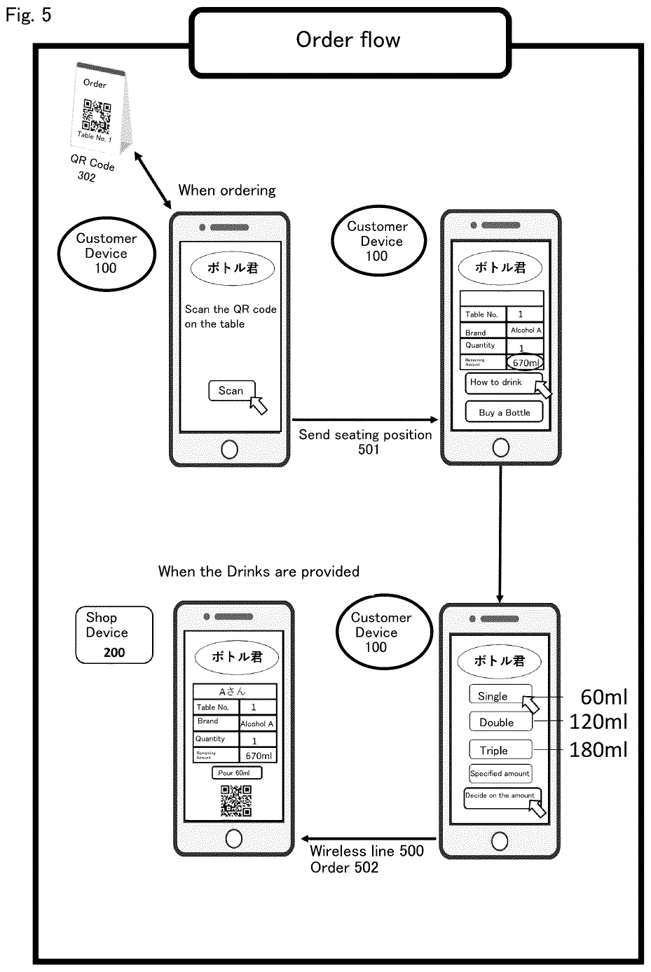

(2) Second step (Entry notification: see FIG. 5):

The shop-side terminal 200 comprises a reception unit 202 that receives an order of an amount of alcohol of a desired quantity from the customer-side terminal 100, so that, (2)-1) when the customer visits the shop, the two-dimensional code 302 represented by QR code of the sitting position is read by the user terminal 100 and (2)-2) the entry sitting signal 501 is transmitted to the shop-side terminal 200, and this is accepted. In addition, (2)-3) when the customer reads the two-dimensional code information 302 represented by QR code of the seating position seated on the customer-side mobile terminal 100 and transmits the entry signal 501, (2)-4) a table number is displayed on the bottle icon (bottler) 103, and the number and the remaining amount are displayed together with the kept bottle brand.

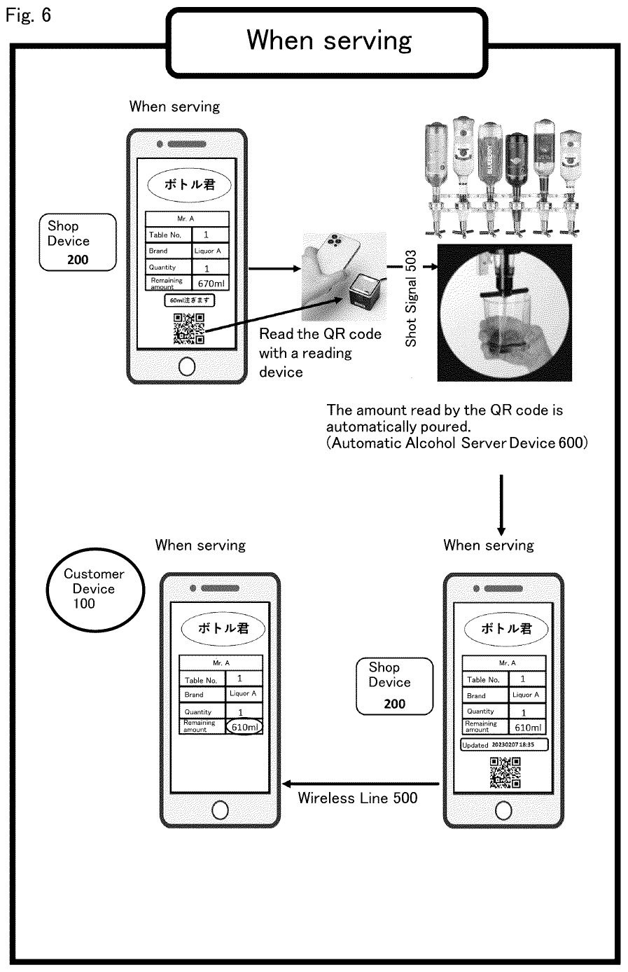

(3) Third step (order notification: see FIG. 6):

(3)-1) When the customer transmits an order signal 502 to request a specified amount of alcohol to the shop-side terminal 200 from the virtual bottle icon 103 at the user terminal 100, the shop-side terminal 200 determines that the customer's order signal 502 has been received from the bottle icon 103 of the user terminal 100 in a state where the entry seat signal is received, the order is determined, and (3)-2) the shot signal 503 of the desired amount is transmitted to the automatic alcohol server device 600 to provide the desired amount of alcohol. Specifically, the bottle icon 103 has a drinking mode button. When clicked, the single, double, triple or free designation amount are displayed, then one of them is selected. Further, (3)-3) when clicking the display of “pour alcohol” is transmitted to the shop-side terminal 200, the shot signal 503 is sent to the automatic alcohol server device 600.

(4) Fourth Step (Update Notification):

(4)-1) When a desired quantity of liquor is provided in response to the customer's order, the store-side terminal 200 comprises an updating unit 203 that subtracts from the storage amount of the virtual bottle, so that the liquor amount is updated by subtracting from the storage amount of the virtual bottle from the designated virtual bottle, and (4)-2) the update data 401 is transmitted to the user terminal 100.

(5) Fifth step (backup):

Whenever the update is performed or when the customer opens a store, the store-side terminal 200 transmits the updated data 401 to the user terminal 100 and transmits it to the backup terminal 400.

(6) Others:

After leaving the store, the customer can check the current state of the bottle via the bottle icon 103 of the user terminal 100 outside.

In the sake providing process (see FIG. 6), when the order signal 502 from the customer-side terminal 100 is a two-dimensional coded represented by QR code, the shop-side terminal 200 can receive the order signal 502 as a two-dimensional code represented by QR code (see FIG. 5). When the shop-side terminal 200 receives the order signal 502 as a two-dimensional code represented by a QR code, the automated alcohol server device 600 has a two-dimensional code reader 601 represented by a QR code. Thereby the two-dimensional code reader 601 can read the order signal 502 from the customer, and can complete the supply of alcohol with updating the remaining amount of the virtual bottle of the shop-side terminal 200 and also the customer-side terminal 100 by transmitting by the wireless line 500 in the shop.

According to the above example, the customer obtains a virtual bottle icon via a two-dimensional code 301 represented by a store QR code,. The customer can show his or her virtual bottle to the store side via a seating code 302 when entering the store, and can send an order signal 502 to the store side terminal 200 via the bottle icon 103. Therefore, the store side can receive the order signal 502 with a two-dimensional code represented by a QR code, so that the supply of the ordered liquor is completed by causing the order signal 502 to be read to the two-dimensional code reader 601 of the automatic liquor server device 600. On the other side, since the remaining amount of the virtual bottle on the store side and the customer side can be updated, this system ca n prevent any forgetting operation to renew and always realizes automatic managing operation in the virtual bottle system.

In the above embodiment, the QR code is used as the two-dimensional code, but another two-dimensional code may be used. Further, in the virtual bottle management system, the alcohol ordered via the store-side terminal is supplied by using the automatic alcohol server device, but the alcohol server system can be used as an alcohol sales management system in no-man store. That is, since the automatic sake server system comprises 1) a customer side terminal (user terminal) 100 such as the smartphone and the tablet, 2) a store side terminal 200 having a function capable of communicating with the user terminal 100, 3) a two-dimensional code system 300 having at least a member QR code 301 for registering a member and a visit QR code 302 for specifying a visit, and 4) a terminal 400 for backing up data of the store side terminal 200, and 5) a system for managing these in cooperation with a wireless line 500. In this no-man or automatic selling store, the customer-side terminal 100 has a function of inputting personal identification information such as an age, a face, a fingerprint of a customer, when the user is registered with the two-dimensional member code 301. On the other hand, the registration unit 201 of the store-side terminal has a function of registering personal authentication information such as the age of a member, a face, and a fingerprint. Therefore, when the shop side may include the automatic alcohol server device 600 including the two-dimensional code reader 601 that reads the order signal 502, the automatic alcohol server device 600 can read the order signal 502 indicated by QR code from the customer terminal 100 directly or via the store terminal 200 by the two-dimensional code reader 601, the shop side terminal 200 can confirm the person authentication information such as the age, face, and fingerprint of the customer. As a result, when the order can be permitted, a shot order signal 503 can be transmitted to supply alcohol from the automatic alcohol server device 600, while updating the record of the virtual bottle of the store terminal 200.

Though a two-dimensional code system and an in-store wireless line are used as a communication unit, a part or all of the same system can be made by a person skilled in the art by a non-contact connection system using a NFC system and a NFC tag.

### Explanation of Reference Numerals

100 Customer side terminal
103 Virtual bottle icon
200 Store side terminal
300 Two dimensional code system represented by QR codes
400 Backup system
500 In-store wireless line
600 Automatic alcohol server device

1. A method for managing a virtual bottle in a system which includes 1) a customer side terminal (user terminal) such as a smartphone and a tablet, 2) a store side terminal having a function capable of communicating via the user terminal and the wireless line in the store, 3) a two dimensional code system comprising a store QR code for registering a virtual bottle together with a store name and a seating QR code for specifying a visiting seat position, 4) a terminal for backing up data of a store side terminal, and 5) an in-store wireless line in order to store a keep of a virtual bottle B in place of an actual bottle together with member information of a bottle purchaser, the method comprising:
a first registration step in which the user terminal is provided with a reading means of the two dimensional code system, and a communication function which cooperates with the store side terminal via the two dimensional code system, where a customer reads the store QR code by the user terminal and communicates with the store side terminal to register customer registration information with the store side terminal, purchase a bottle, and obtain the bottle icon used as virtual bottle keeping proof from the store side,
a second requesting step in which the store side terminal is provided with a virtual bottle registering means which records a virtual bottle with membership information instead of an actual bottle, and a receiving means which receives an actual bottle, the order of the quantity of the quantity of a selected liquor from the customer side terminal, wherein a customer comes to the store, reads the QR code of a seating position with the user terminal, and transmits the on-store seating signal to the store side terminal,
a third ordering step in which the customer transmits an order signal, wherein the customer requests a specified amount of alcohol from his virtual bottle to the store-side terminal from the virtual bottle icon in the user terminal,
a fourth updating step in which, the store side terminal is further provided with the updating means which subtracts from the storage quantity of a virtual bottle, wherein, when the amount of alcohol of quantity of a request is provided in response to a customer's order, and the store side, the order is determined by reception of the seating signal and the ordering signal, the amount of alcohol is subtracted from the storage quantity of a virtual bottle, and
a fifth step in which, the store side further transmits the updated data to a user terminal and also transmits the updated data to a backup terminal.

2. The method for managing a virtual bottle according to claim 1, wherein the in-store wireless line has a cross-wave communication such as Bluetooth or Wi-Fi or similar communication capability.

3. The method for managing a virtual bottle according to claim 1, wherein the virtual bottle registration unit of the shop-side terminal has a personal authentication function for checking a customer's information such as an age, a face and a fingerprint.

4. The method of managing a virtual bottle according to claim 1, wherein the seating signal and the order signal are executed by the order terminal instead of the user terminal.

5. The method of managing a virtual bottle according to claim 1, wherein the system further comprises an automatic alcohol server device cooperating with the shop side terminal, wherein, when the shop side terminal receives the seating signal and the order signal, a shot signal is transmitted to the automatic alcohol server device, and an amount of alcohol stored in a virtual bottle is updated by the updating unit of the shop side terminal.

6. The method of managing a virtual bottle according to claim 1, where the customer contacts the backup terminal via an Internet line via the user terminal to confirm the remaining amount of alcohol via the bottle icon outside.

7. The method of managing a virtual bottle according to claim 1, wherein the automatic liquor server device includes a two dimensional code reader for reading a two dimensional code represented by a QR code to make the order signal of the customer side terminal converted into a two dimensional code represented by a QR code and to directly read from the customer side terminal by the two dimensional code reader or to be received by the shop side terminal, whereby the ordered alcohol is supplied from the automatic liquor server device by a shot signal, and a record of a virtual bottle of the shop side terminal is updated.

8. A system for managing a virtual bottle comprising:
a customer side terminal (user terminal) such as a smartphone and a tablet,
a store side terminal having a function capable of communicating via the user terminal and the wireless line in the store,
a two dimensional code system comprising a store QR code for registering a virtual bottle together with a store name and a seating QR code for specifying a visiting seat position,
a terminal for backing up data of a store side terminal, and
an in-store wireless line in order to store a keep of a virtual bottle B in place of an actual bottle together with member information of a bottle purchaser,
an automatic sake server device for supplying sake in response to an order signal from the customer side terminal provided with a two-dimensional code reader for receiving the order signal directly from the customer side terminal or through the store-side terminal,
wherein:
the customer side terminal has a function for inputting a personal authentication information of the customer, such as a customer's age, a face, and a fingerprint, together with the membership registration, while the store side terminal has the registering means for recording personal authentication information, such as a member's age, a face, and a fingerprint, and
the automatic alcohol server device is provided with a function for confirming whether the order signal through the 2 dimensional code reader is allowable or not under the personal authentication information and then a shot signal issues if permitted, so resulting in that while supplying alcohol from an automatic alcohol server device, a record of a virtual bottle of a store side terminal is updated.
